(19) United States
(12) Patent Application Publication
(10) Pub. No.: US 2012/0241532 A1
(43) Pub. Date: Sep. 27, 2012

(54) Pyrethrin Based Repellant

(76) Inventors: Kent M. Palkki, Racine, WI (US); Murthy S. Munagavalasa, Racine, WI (US)

(21) Appl. No.: 13/070,744

(22) Filed: Mar. 24, 2011

(51) Int. Cl. B05D 1/02; A01N 43/90; B67D 7/08; A01N 25/00; A01P 7/04; A01P 17/00; A01N 53/10; A01N 65/12

(52) U.S. Cl. 239/1; 514/531; 514/530; 514/464; 514/65; 514/67; 424/43; 424/45; 222/638

(57) ABSTRACT

Disclosed herein are insect repellant formulations and dispensing systems which avoid the need for synergists while still using highly effective pyrethrin repellant compounds. The formulations preferably are presented in aerosol form.

### CROSS-REFERENCE TO RELATED APPLICATIONS

Not applicable.

### STATEMENT REGARDING FEDERALLY SPONSORED RESEARCH/DEVELOPMENT

Not applicable

### BACKGROUND OF THE INVENTION

The present invention relates to aerosolized insect repellant formulations which use pyrethrin as a repellant active. More particularly, it relates to such formulations which achieve high repellency without the need for significant amounts of synthetic synergists such as piperonyl butoxide or N-octyl bicycloheptene dicarboximide (“MGK-264”).

Insect repellants have become increasingly important, particularly in geographical regions having concerns regarding controlling malaria and other insect-born diseases. Various dispensing techniques are used to dispense such repellants. For example, insect coils or other burnable structures dispense repellants during a burning process. However, this requires structures and other precautions for the appropriate handling of burnable materials.

Another approach is to include a repellant in a container having a wick therein. The wick draws the active dissolved in a solvent up adjacent an electrical heater, and the active is driven from the wick by the heat. However, this requires electronic power sources which can limit portability.

Still another approach that is the most pertinent to the present invention is to provide the active in an aerosol container and then manually or via an automated mechanism intermittently spray the active in a room or other area to be protected. See e.g. U.S. Pat. No. 6,588,627.

A variety of chemicals are known to have insect repellency capability. These include DEET, some pyrethroid-type insecticides, and some natural extracts from plants and other materials (e.g. citronella, eucalyptus, lemon leaves, peppermint, lavender, cedar oil, canola, rosemary, pennyroyal and cajeput). For example, an extract of pyrethrum (a member of the chrysanthemum flower family) is known to have insecticidal capability when used with a synthetic synergist. It has also been noted that such formulations with a synthetic synergist also have some repellency capability.

Pyrethrum is sometimes colloquially referred to as “pyrethrin”, albeit the extract itself is actually a mixture of pyrethrin I with pyrethrin II, usually in combination with other active ingredients such as Cinerin I, Cinerin II, Jasmolin I and Jasmolin II.

Pyrethrin I is chemically identified as 4-hydroxy-3-methyl-2-(2,4-pentadienyl)-2-cyclopenten-1-one 2,2-dimethyl-3-(2-methyl-propenyl) cyclopropanecarboxylate (a/k/a a pyrethrolone ester of chrysanthemummonocarboxylic acid). Pyrethrin II is chemically identified as 4-hydroxy-3-methyl-2-(2,4-pentadienyl)-2-cylopenten-1-one 1-methyl-3carboxy-2,2-trimethylcyclopropaneacrylate ester (a/k/a a pyrethrelolone ester of chrysanthemumdicarboxylic acid monomethyl ester).

Decades ago it was discovered that pyrethins were not very effective as insecticides without the use of a synergist. Thus, U.S. Pat. No. 2,410,101 described an aerosolized spray of insecticide which contains a mix of pyrethrins I and II, a hydrocarbon in the form of kerosene, a propellant in the form of CCl₂F₂, and about 2% of a synergist in the form of sesame oil.

Similarly, U.S. Pat. No. 4,295,581 taught an aerosol spray of insecticide using pyrethin, the synergist piperonyl butoxide (“PBO”), Isopar M isoparaffinic hydrocarbon, and freon propellant.

However, it is important to wide application of aerosolized pyrethrin based insect control formulations in those third world and other poor areas most likely to have malaria and other insect born disease concerns that the cost of using repellants be minimized to the extent possible. Synergists such as PBO add additional costs relative to the hydrocarbon solvent or propellant that they replace when they are used in pyrethrin formulations. Also, PBO and certain other synergists are sometimes perceived as non-natural ingredients which can present some marketing concerns to those who wish to minimize the use of non-natural ingredients in their environment.

All documents cited in the Background Of The Invention are, in relevant part, incorporated herein by reference. The citation of any document is not to be construed as an admission that it is prior art with respect to the present invention.

Hence, a need exists for the development of improved formulations of pyrethin based aerosolized insect repellants.

### BRIEF SUMMARY OF THE INVENTION

The present invention provides in one aspect an insecticidal aerosol formulation comprising a pyrethrin, a solvent containing the pyrethrin, and a propellant gas, and less than 0.025% synergist (e.g. no synergist). The formulation is synergist free. In a preferred form the formulation comprises a mixture of pyrethrin I and pyrethrin II, such as would be found in a typical pyrethrum extract.

In other preferred forms the solvent is a hydrocarbon solvent such as an isoparaffinic solvent (e.g. Isopar H, L or C from ExxonMobil), and the propellant gas contains one or more hydrocarbons having less than six carbons (e.g. hydrocarbon gases selected from the group consisting of propane, butane and isobutane). For use in an automated dispensing device, it is desirable that there be at least 0.3% pyrethrin, more preferably at least 0.5% pyrethrin, and that there be less than 5% pyrethrin. Below that range the repellant may not be adequately effective, and at higher concentrations above that range the cost of the formulation increases becomes problematic for likely markets. It is desirable that the propellant gas be from 40% to 80% of the formula, and that the solvent be from 20% to 60% of the formula.

In another aspect the invention provides a method for repelling insects (e.g. mosquitoes or other flying or crawling insects) from a selected area comprising spraying into the area an insect formulation in aerosol form. The formulation when sprayed preferably has a D(v,0.9) particle size which is equal to or less than 46 microns, and contains pyrethrin, a hydrocarbon solvent, and optionally a propellant gas. The formulation is essentially synergist free (below 0.025% w/w). With respect to particle size distribution we prefer D(v,0.9)=Volume diameter; that is, preferably 90% of the total volume of liquid is in drops of smaller diameter and 10% is in drops of larger diameter. Particle size is measured via laser diffraction at 20 centimeters from the laser beam using a Malvern Spraytec instrument. The formulation when sprayed preferably has a D(v,0.9) particle size which is equal to or less than 46 microns, with a hydrocarbon solvent, and optionally a propellant gas.

In a preferred form the spraying is provided by an automated intermittent sprayer which releases a burst of spray from 5 milliseconds to a few seconds in duration and then turns off for a selected time such as five minutes to three hours every twenty minutes. Thereafter the cycle is repeated. Alternatively, the sprayer may be designed to have a greater spraying volume, or less time between sprays, when first turned on. This may prepare a room for use. Thereafter, longer durations between sprays or less spraying per spray may be programmed such that the room can be maintained as safe. Thus, fresh active is dispensed, and this is particularly effective.

Notwithstanding decades of understanding in the art that it was important to use significant levels of synergist with pyrethrin for effective insect control, it has been surprisingly learned that the synergist can be essentially removed from insecticidal formulations to create effective repellants, particularly when pyrethrin concentration and dosage are controlled. This lowers the cost of the resulting formulation, thereby rendering it more practical for use in poor geographical areas. Also, this removes a synthetic compound from the formulation, thereby rendering it more natural from a marketing perspective.

These and other advantages of the present invention will be apparent from the following description. In the description that follows reference is made to preferred embodiments of the invention. As these embodiments are merely illustrative they are not intended to represent the full scope of the invention. Thus, reference should therefore be made to the claims herein for interpreting the scope of the invention.

### DETAILED DESCRIPTION OF THE INVENTION

One preferred embodiment of the invention is a formulation containing 0.6% pyrethrins, 39.4% of Isopar H (an isoparaffinic hydrocarbon solvent), and 60% of liquid petroleum gas (such as a mixture of propane, n-butane and isobutane). The pyrethin need not be presented in pyrethrum extract form, a variety of other hydrocarbon solvents (particularly isoparaffinic solvents such as Isopar L or C), and a variety of other known aerosol propellant gases can be used (regardless of whether hydrocarbon based).

The primary intended use of these repellants are indoors, such as in rooms that are about 30 m³ in size. Of course, the size of the room is not critical as the larger the room the more repellant used.

Insect knockdown tests were conducted (an indicator of insecticidal effect) comparing formulations with and without significant synergist levels. For example, our product was tested as a composition with 0.9% pyrethin in Isopar H versus a similar composition having PBO as well. 100% mortality was achieved within 3 hours for both types of formulations against mosquitoes.

A repellency test was also conducted to examine a comparison of compounds having the synergist and not having the synergist. The essential absence of the synergist did not cause a significant decrease in effectiveness. Surprisingly, essentially deleting the synergist (particularly when a majority of the particles of the formulation preferably 80%) had 10 to 46 micron diameter, D(v,10) to D(v,90) did not adversely impact repellency against mosquitoes.

While preferred embodiments of the present invention have been described above, it should be appreciated that there are still other embodiments of the invention within the spirit and scope of this disclosure. For example, pyrethin can be used in pure form, apart from pyrethrum extract. Also, using the automated intermittent sprayer provides a fresh, more effective, spray. Hence, the invention is not to be limited to just the specific embodiment shown and described.

### INDUSTRIAL APPLICABILITY

The invention provides improved insect repellant formulations which are aerosolized pyrethin based, as well as methods for using them.

What is claimed is:

1. An insecticidal formulation comprising:
a pyrethrin; and
a solvent in which the pyrethrin is dissolved;
wherein the formulation is either free of synergist or has less than 0.025% of sesamin.

2. The formulation of claim 1, wherein the formulation is an aerosol formulation and comprises a mixture of pyrethrin I and pyrethrin II.

3. The formulation of claim 2, wherein the pyrethrin I and pyrethrin II are part of a pyrethrum extract.

4. The formulation of claim 1, wherein the solvent is a hydrocarbon solvent, and there is also a propellant gas.

5. The formulation of claim 1, wherein the hydrocarbon solvent is an isoparaffinic solvent.

6. The formulation of claim 5, wherein the gas comprises hydrocarbons having less than six carbons.

7. The formulation of claim 6, wherein the gas comprises a hydrocarbon gas selected from the group consisting of propane, butane and isobutane.

8. The formulation of claim 1, comprising at least 0.3% pyrethrin.

9. The formulation of claim 1, comprising at least 0.7% pyrethrin.

10. A method for repelling insects from a selected area comprising spraying into the area an insect formulation in aerosol form, the formulation comprising:
pyrethrin;
a hydrocarbon solvent; and
a propellant gas;
wherein the formulation is either free of synergist or has less than 0.025% sesamine.

11. The method of claim 10, wherein the formulation when sprayed has 80% of the particles D(v,0.1) to D(v,09) are between 10 and 46 microns in diameter.

12. The method of claim 11, wherein the insects are mosquitoes.

13. The method of claim 11 where the spraying is provided by an automated intermittent sprayer which sprays the formulation with intervals of at least five seconds between spraying.

14. An intermittent dispensing system for dispensing an insecticidal formulation which is capable of delivering a formulation comprising:
pyrethrin;
a hydrocarbon solvent; and
a propellant gas;
wherein the formulation is either free of synergist or has less than 0.025% sesamine, and the dispensing system sprays the formulation within intervals of at least five seconds between spraying.

15. The intermittent dispensing system of claim 14, wherein the formulation when sprayed has 80% of its particles D(v,0.1) to D(v,09) between 10 and 46 microns in diameter.
